(19) United States
(12) Patent Application Publication
(10) Pub. No.: US 2010/0183302 A1
(43) Pub. Date: Jul. 22, 2010

(54) OPTICAL SWITCH

(75) Inventors: Michael Lamvik, Durham, NC (US); Scott Goodwin, Hillsborough, NC (US); Gary E. McGuire, Chapel Hill, NC (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Research Triangle Institute, Research Triangle Park, NC (US)

(21) Appl. No.: 12/663,610

(22) PCT Filed: Apr. 16, 2008
(86) PCT No.: PCT/US08/60482

§ 371 Date: Dec. 8, 2009

Related U.S. Application Data
(60) Provisional application No. 60/942,747, filed on Jun. 8, 2007.

(51) Int. Cl. H04J 14/00; G02B 6/26; G02B 6/36

(52) U.S. Cl. 398/45; 385/16; 385/89

(57) ABSTRACT

An optical device for switching an optical signal between a first optical path and a second optical path, including a substrate, a first guide forming at least a portion of the first optical path, formed on the substrate, and having a movable portion separated from the substrate, a second guide forming at least a portion of the second optical path and disposed adjacent to the first guide, and means for electro statically bending the movable portion so as to optically couple the first guide to the second guide.

### BACKGROUND OF THE INVENTION

1. Field of the Invention

The present invention is related to optical switches, a method for forming the optical switches, devices that include optical switches, and methods for integrating the switches into cross-connects, multiplexers and other optronic structures.

2. Description of the Related Art

Electronic switches for optical fiber communications are expensive and complicated. They require the signal to be converted from optical to electronic mode before switching can occur. All-optical switches simplify the transmission of the communications signal by avoiding such conversion, but conventional all-optical switches present problems with switching speed, wavelength range or mechanical complexity.

The fastest optical switches are expensive, not only due to the cost to make them, but also because of the power required to operate them. In addition, conventional mirror-based switches are sensitive to vibration because of the complicated actuation mechanism that switches the optical communications signal within the switch. Presently, it is common that large and expensive optical switches are used in the main lines of optical communications transmission circuits, where the large cost is justified by a large volume of data. Soon, optical switches will be needed closer to the consumers' homes and also inside the consumer's house. Thus, there is a need for inexpensive, compact, and stable optical switches.

Some optical fibers are provided near residential developments and in some cases are provided directly into people's homes. However, the present entertainment equipment (TV, set-top receiver, modem, etc.) inside the residences require an electrical signal and thus, the provider of the optical signal conventionally transforms the optical signal provided through the optical fiber into an electric signal that is fed to the residential equipment. To use the full potential of the optical fibers, optical equipment should be used inside the residences. Such an application will need low-cost and high-volume switches.

Also, it is known that optical circuits are being placed in aircrafts and even in automobiles. Such applications could utilize optical switches that are particularly insensitive to vibrations.

The conventional switches are actuator-driven switches, including switches operated electrostatically. Typically, an electrostatic operation is seen in mirror switches, not with moving guides. This typical switch has a fixed input optical guide and a small mirror formed on a movable substrate. The substrate is actuated to move at different positions such that, an incident light from the input optical guide to the mirror, changes with the movement of the mirror. By calculating the movement of the mirror relative to the receiving optical guides, the light from the input optical guide is deviated as desired to one of the receiving optical guides. However, these conventional switches are sensitive to vibrations, and difficult to build and align.

Other optical switches use an incoming fiber and two outgoing fibers attached to an actuation chamber. Electrodes are provided underneath the actuation chamber to move both the incoming fiber and the outgoing fiber to align with each other, as disclosed in Herding et al (“A new micromachined optical fiber switch for instrumentation purposes,” MEMS, MOEMS, and Micromachining, Proc. of SPIE, Vol 5455, Bellingham, Wash., 2004), the entire content of which is included by reference herein.

There are other optical switches where the entire light path of the switch element is made of a single material. These switches include guides fully made of polymers. One example is a polymer switch in which the total internal reflection is used to direct light in one direction. This switch is actuated by a heater by changing the temperature of the polymer and hence changing the index of refraction of a section of the guide. Depending on the index of refraction, light is guided either by total internal reflection to one output guide or by direct transmission into another guide. The similar mechanism of changing the index of refraction can be used to make an interferometer switch. In either case, the design requires heaters, which use more power than an electrostatic mechanism.

For example, Holman et al. disclose a micro-optic switch with lithographically fabricated polymer alignment features for positioning the switch components and optical fibers in U.S. Pat. No. 6,169,827, the entire contents of which is incorporated herein by reference. Holman et al. show a method of bending optical fibers to connect with one of two contact points. However, Holman et al. use complex microfabricated devices that are used to position the optical fiber as required for the switching operation. However, each known MEMS mechanism uses combinations of actuators and guides, that are difficult to align, and the guides are fixed to a substrate.

Marcuse et al. disclose a polymer guide switch and method in U.S. Pat. No. 6,144,780, the entire contents of which is incorporated herein by reference. Marcuse et al. show polymer members being used as light-guides. However, the polymer members of Marcuse et al. are fixed to the substrate and the switch operates through a thermal mechanism.

### SUMMARY OF THE INVENTION

According to an aspect of the present invention, an optical device for switching an optical signal between a first optical path and a second optical path, includes a substrate, a first guide forming at least a portion of the first optical path, formed on the substrate, and having a movable portion separated from the substrate, a second guide forming at least a portion of the second optical path and disposed adjacent to the first guide, and means for electrostatically bending the movable portion so as to optically couple the first guide to the second guide.

According to another aspect of the present invention, an optical device for switching an optical signal between a first optical path and a second optical path, includes a substrate, a first guide forming the first optical path, formed on the substrate, and having a movable portion separated from the substrate, the movable portion including, an end face disposed at a longitudinal end of the movable portion, and first and second side walls adjoining the end face, a first conducting layer formed on the first side wall of the movable portion, a first electrode protruding from the substrate, opposing the movable portion, and configured to electrostatically bend the movable portion of the first guide when a first voltage is applied between the first electrode and the first conducting layer, and a second guide forming the second optical path, disposed adjacent to the end face of the first guide, and optically coupled to the first guide when the movable portion of the first guide is electrostatically bent by the first voltage.

According to another aspect of the present invention, an optical device for switching an optical signal from an input optical path to one of plural output optical paths, including a substrate, an input guide forming the input optical path, formed on the substrate, and having a movable portion separated from the substrate, the movable portion of the input guide including, an end face disposed at a longitudinal end of the movable portion, and side walls adjoining the end face, conducting layers formed on the side walls of the movable portion, and electrodes connected to the substrate, separated from the input guide, opposing respective ones of the conducting layers, at least partially surrounding the movable portion of the input guide, and configured to electrostatically bend the movable portion of the input guide when a corresponding voltage is applied between one of the electrodes and one of the conducting layers, output guides forming the output optical paths disposed adjacent to the end face of the input guide, and the input guide is optically coupled to a selected one of the plural output guides when the movable portion of the input guide is electrostatically bent.

According to another embodiment of the present invention, a method for switching an optical signal between a first guide and a second guide, includes introducing the optical signal into a movable portion of the first guide formed on a substrate, the movable portion separated from the substrate supporting the movable portion, and applying a first voltage between a first conducting layer formed on a first side wall of the movable portion and a first electrode on the substrate, to electrostatically bend the movable portion of the first guide to optically couple the first guide to a second guide disposed on the substrate and adjacent to the end face of the first guide.

According to another embodiment of the present invention, a method for switching an optical signal from an input guide to one of manifold output optical guides, includes introducing the optical signal into a movable portion of the input guide formed on a substrate, the movable portion separated from the substrate, and applying a voltage between one of conducting layers formed on side walls of the movable portion of the input guide and one electrode of electrodes at least partially surrounding the movable portion of the input guide, to electrostatically bend the movable portion of the input guide to selectively optically couple the input guide to a selected one of the manifold output optical guides.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram depicting an overall picture of a guide formed between two electrodes;

FIG. 2 is a diagram depicting an optical switch having an input guide and two output guides;

FIG. 3 is a diagram depicting a device of FIG. 2 with electrode blocks being aligned with the output guides;

FIG. 4 is a diagram depicting a device of FIG. 3 with the input guide bent;

FIG. 5 is a diagram depicting an optical switch according to another embodiment of the present invention;

FIG. 6 is a diagram depicting an input guide and electrodes that determine a vertical movement of the guide;

FIG. 7 is a diagram depicting an input guide encompassed by a plurality of electrodes;

FIGS. 8a-c are schematic representations of an optical switch and a circuit that includes a plurality of optical switches;

FIG. 9 is a schematic illustration of an integrated optical cross connect having twelve optical switches;

FIG. 10 is a schematic illustration of a router including a plurality of optical switches;

FIG. 11 is a schematic illustration of the optical switch and a key to materials used;

FIGS. 12-23 are schematic illustrations of various steps in the processing of the guide; and

FIGS. 24 and 25 are schematic illustrations of the processed guide across different cross-sections.

### DETAILED DESCRIPTION OF THE PREFERRED EMBODIMENTS

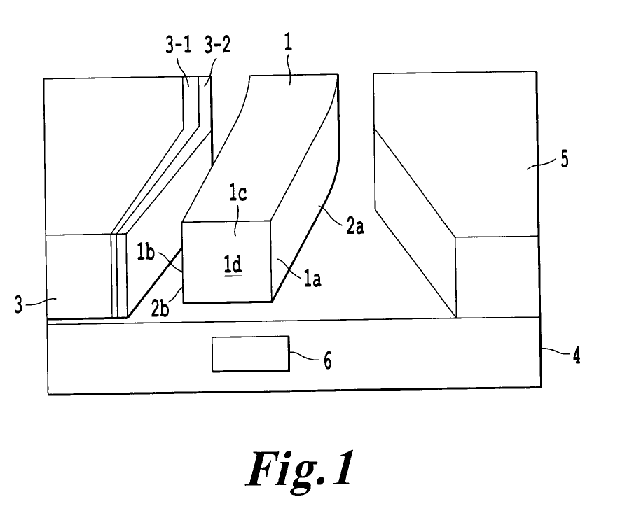

Referring now to the drawings, wherein like reference numerals designate identical or corresponding parts throughout the several views, FIG. 1 shows a schematic of a guide 1 formed between two electrodes 3 and 5 on a substrate 4. Guide 1 is integrally attached but has a movable portion separated from the base substrate. The integral attachment and desired separation provides a robust movable portion whose position is well defined and whose elastic properties are predictable and reproducible for extended cycles. A mechanism is provided to electrostatically bend the movable portion to transmit an optical signal from guide 1 to another guide as will be disclosed in more details next.

The guide 1 may be in one embodiment a waveguide as for example, an optical fiber. However, guide 1 may be an optical material that permits total internal reflection of an optical signal, thus the propagation of the optical signal from one end of the guide to the other end of the guide. In other words, a cross-section size of guide 1 can be randomly chosen without taking into account a cut-off frequency. The guide 1 in this embodiment has a rest position in which no voltage is applied to the electrodes 3 and 5. The guide 1 in this embodiment has at least one electrode 2a formed on a side face 1a of the guide 1. The guide 1 may have two electrodes, a first electrode 2a on side 1a and a second electrode 2b, on side face 1b of the guide 1.

The guide 1 in one embodiment is formed, as will be discussed later, to have (i) an end face 1c, and (ii) side faces 1a and 1b adjacent to the end face 1c such that the end face 1c and the adjacent side faces of the guide 1 are movable, i.e., form a movable portion 1d. In other words, in this embodiment a distal portion of the guide is movable and has a cantilever structure.

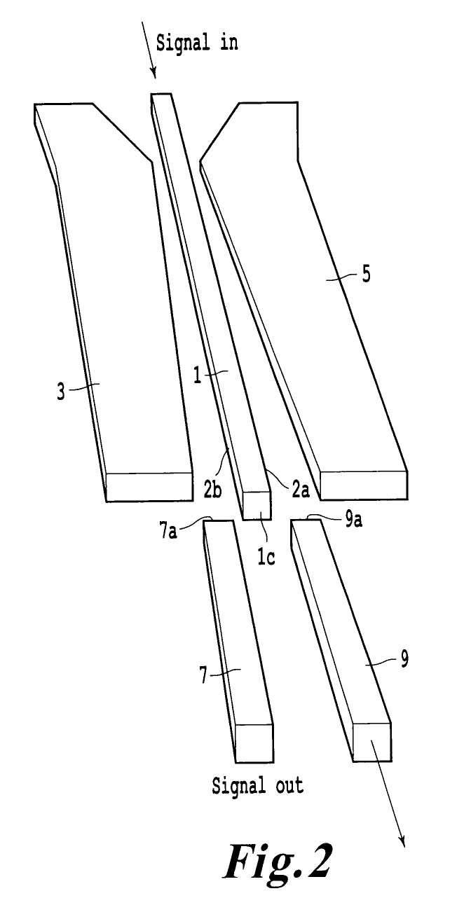

In this way, the end face 1c and an adjacent portion of the end face may bend towards the electrodes 3 or 5 when an appropriate voltage is applied between electrodes 2a and 5 or electrodes 2b and 3. In one embodiment, block electrode 3 can have the body made of an insulating material and an electrically conductive part 3-1 is formed on a face of the block electrode 3, with an insulator 3-2 covering the conductive part 3-1 to prevent direct contact between the conductive part 3-1 and the electrode 2b. By applying the appropriate voltage (as will be discussed later), the end face 1c of the guide 1 moves and aligns with another guide 7 or 9 (see FIG. 2) until the end face 1c of the guide 1 faces end faces 7a or 9a of the guides 7 or 9, respectively. Thus, in this embodiment, an optical signal 11 that is input to the guide 1 is transmitted either to the guide 7 or to the guide 9, achieving the desired optical switching by applying an appropriate voltage.

According to this embodiment, no heaters or rods are necessary to bend guide 1. According to this embodiment, electrodes 2a and 2b are formed integrally with guide 1 such that guide 1 itself is the actuator. Also, the switch shown in this embodiment has a moving switching element which is held firmly in place by the applied electrostatic force. Thus, the device of this embodiment is not sensitive to vibrations.

In one embodiment, a fluid medium fills the space between the ends of the input guide 1 and the output guides 7 and 9 to limit reflections at the interface between the ends and a gap space between the guides. To perform this function, the index of refraction of the medium may be greater than that of air, but less than that of light-conducting core of the light guides. Examples of such possible media are index-matching fluids LS-5229 and LS-5241-10 (available from NuSil Technology, Wareham, Mass.), with index of refraction values of approximately 1.3 and 1.4, respectively.

In one embodiment, a conductive metal electrode 6 is provided in the substrate 4, as will be shown in more details in FIG. 12, opposite and directly under the movable portion 1d to prevent the movable portion 1d to be attracted to the substrate 4 on which the guide 1 is formed. When electrodes 2a and 2b on the movable portion of the light guide are electrically charged, an opposite charge may be induced in the dielectric surface below the light guide, causing the movable portion 1d to be attracted to a surface of substrate 4. For the movable portion, this poses a problem in alignment of the end of the movable portion to the subsequent optical guide. If metal electrode 6 is placed below the insulating dielectric, and the electrode 6 is held at the same electrical potential (voltage) as electrodes 2a and 2b on the movable portion, then no differing electrical charge is induced, and there is no force drawing the movable portion toward the substrate.

In one embodiment, the movable portion 1d of the light guide has dimensions of approximately 8 μm×10 μm×700 μm. This yields a volume of 5.6×10⁺⁴ μm³ or 5.6×10⁻⁵ mm³ or 5.6×10⁻⁸ cm³. A typical density for transparent, unfilled, polyimide that may be used in the optical switch is 1.42 g/cm³. This yields a mass of about:

5.6×10^{˜8} cm³×1.42 g/cm³=8×10⁻⁸ g.

This example is for illustrative purposes and not to limit the disclosed movable portion to a mass as calculated above. The length of the movable portion may also be in a range from 500 to 1500 μm. This would yield a range in mass from about 5.7×10⁻⁸ g to 1.7×10⁻⁷ g. In addition, the cross-sections of the light guides may be square, rectilinear, or other designed section.

One feature of the optical switch shown in FIG. 2 is that a guide is used to convey the light signal from input to output, and at the same time the same guide is the actuator for the switching mechanism, permitting the guide of this embodiment to be compact, inexpensive, and stable to vibrations. Another advantage of this embodiment is that a guide having the movable portion is formed integrally with the substrate. In addition, it is possible in one embodiment to fabricate on the substrate a plurality of fibers and electrodes that will form a switch or plural switches, these elements being formed during a same process, thereby saving time, space, and resources.

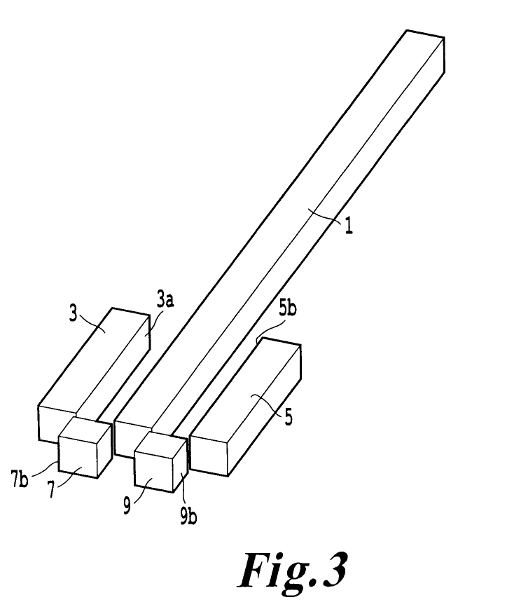

FIG. 3 shows in one embodiment guide 1 in a rest position, between the guides 7 and 9. In this position, no voltage is applied to the electrodes of the guide 1 and the electrodes 3 and 5. The electrodes 3 and 5 serve not only to produce the necessary electrostatic force for actuating the guide 1 but also to provide the necessary alignment between the guide 1 and the guides 7 and 9. In this regard, sides 3a and 5b of the electrodes 3 and 5, respectively, are aligned with sides 7b and 9b, respectively, of the guides 7 and 9.

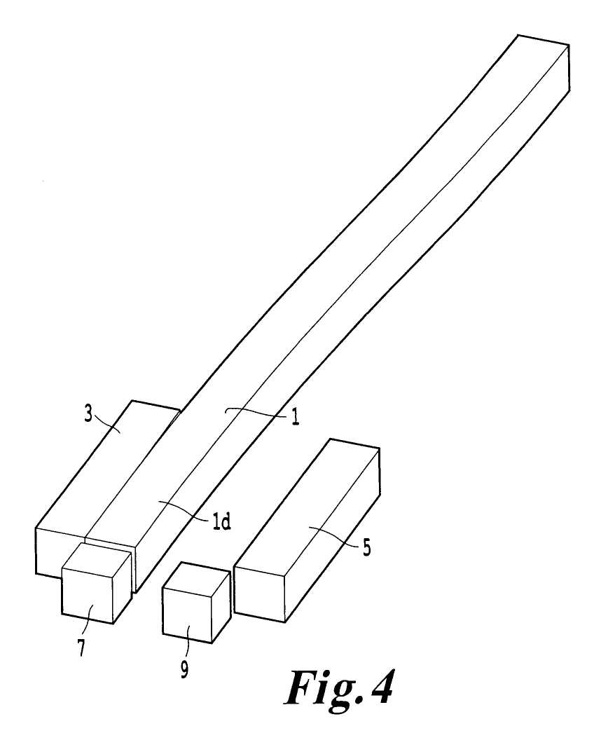

Based on this alignment, when an appropriate voltage is applied between electrode 2b of guide 1 and electrode 3, the guide 1 is bent to the position shown in FIG. 4, until the guide 1 contacts electrode 3. Note that an insulating layer is placed between electrode 3 and electrode 2b either on the side of the guide 1 or on electrode 3 to prevent an electrical short-circuit between the electrodes. The insulating layer is described in more details later with regard to FIGS. 22-25. In this position, the side 1b of the guide 1 is aligned with side 7b of electrode 7, and an input optical signal is transmitted from guide 1 to the guide 7. Alternatively, the guide 1 may be bent and aligned with guide 9 by applying an appropriate voltage between electrode 2a of guide 1 and the electrode 5.

Electrode blocks 3 and 5 in one embodiment can be positioned to have a V shaped, oblique position as shown in FIG. 2, or parallel to each other and to guide 1 as shown in FIG. 3. Optionally, electrode blocks 3 and 5 can be positioned misaligned from each other. Alternatively, the portion of the electrodes 3 and 5 nearest the gap may be parallel to the guides 7 and 9, to enhance alignment, and the portion of the electrodes farther from the gap may be oblique, to enhance the electrostatic “zipping” effect between the electrodes. Also, the oblique portion may be shaped as a smooth curve rather than a straight line, to enhance the release or “un-zipping” of the guide 1 when voltage is removed.

According to another embodiment, guide 1 is aligned to guide 7 in a neutral position and aligned to the guide 9 when a voltage is applied between guide 1 and electrode block 5. For this embodiment, there is no need for a second electrode block 3. Guide 1 is removed from the guide 9 by reducing the voltage difference to zero between electrode block 5 and electrode 2a on guide 1. Thus, due to the elastic force generated by the bending of the movable portion, guide 1 returns to its neutral position.

FIG. 4 shows an embodiment in which a 50 V voltage is applied between guide 1 and block electrode 3 to align guide 1 with guide 7. A 5 ms time period is simulated for commutating (switching) guide 1 to block electrode 3.

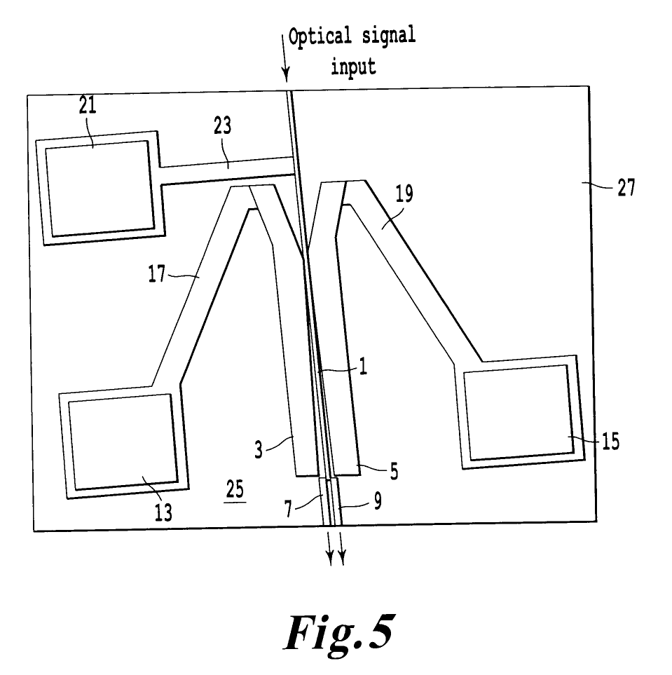

FIG. 5 shows a schematic representation of the guides 1, 7, and 9 and the electrodes 3 and 5 according to another embodiment of the present invention. In FIG. 5, the electrical connections between the electrodes 3 and 5 and corresponding pads 13 and 15 are shown as conducting films 17 and 19. Also, FIG. 5 shows the pad 21 corresponding to the guide 1 connected to the electrode 2a via a conducting film 23. In this embodiment, guide 1 is the input guide and the guides 7 and 9 are the output guides because FIG. 5 shows that an optical signal is input to the guide 1 and output from one of the guides 7 and 9. However, any of the guides can be an input or an output guide. In other words, a selection could be made between one of two inputs rather than directing a single input to one of two outputs.

The optical switch is formed on a substrate, which might be a portion of a silicon wafer as will be discussed later. The substrate can be packaged in conventional ways, for example, by connecting optical fibers to the input and output guides on the substrate, using for example V-grooves in the silicon to locate the optical fibers. Polymer guides take the light from the input fibers into the switching area 25 and from the switching area to other optical elements and to the output fibers. The guides are attached to the surface of the substrate 27 but are optically separated from the surface by a cladding layer. Top and side faces of the guides are immersed in air or some other fluid of lower index of refraction than the guides, hence creating effective optical cladding around the guides. In this way, light is carried along the guide without loss. Optionally, a cladding layer is coated over the optical guides.

Next, a method of using the switch shown in FIG. 5 is discussed. The input guide 1 enters the switching region 25 continuously. A difference between the input guide 1 inside of the switching region 25 and outside of the switching region is that the input guide inside the switching region 25 is separated from the surface of the substrate, allowing it to move relative to the substrate and the guide outside the switching region 25. At the output end of the switching region 25, the cantilevered input guide ends, allowing the light to be switched into the output guides 7 and 9.

In the switching region 25, the two electrode blocks 3 and 5 are placed on either side of the input guide 1. These electrode blocks 3 and 5 permit a voltage to draw the end of the input guide 1 (movable portion) toward whichever electrode block is electrically charged. In this way, the electrode blocks also serve as stopping blocks, holding the input guide in a fixed position. The two fixed positions are arranged so that the light coming from the input guide 1 is directed into one of two output guides 7 and 9. A central neutral position of the guide 1 is not connected to any output, providing an “off” position of the switch. All of the electrodes and guides can be fabricated using the same polymer layer in the micro-fabrication process. To allow for electrostatic operation of the input guide 1 in the switching region 25, a metal such as for example Al and/or Au is disposed (e.g. angle-evaporated) onto a short section of the input guide 1, near the electrode blocks 3 and 5, and on electrode blocks sides facing the guide. The metal may include other materials, such as a thin layer of Titanium (for adhesion) followed by a thicker layer of Tungsten.

The metal electrodes may be connected to outside electrical contact pads 13, 15, and 21. In this way, a structure is achieved in which guide 1 can be drawn to left or right depending on the voltages placed on electrostatic blocks 3 and 5.

In the region of the switch operation 25, the cantilevered input guide is detached from the surface of the substrate, allowing the movable portion 1d to move. This movable portion of the guide 1 is detached from the surface of the substrate 27 by using a removable material during the micro fabrication process, as will be described below. This removable material is specific to the area where the switching action takes place and the remainder of the guide 1 remains attached to the surface of the substrate 27 by the cladding layer.

The operation of the switch shown in FIG. 5 is now discussed. When about 50 volts are placed between one of the electrostatic blocks and an electrode of the guide, this voltage drives the input movable portion 1d of the guide from the neutral position to contact the respective electrode block. As will be discussed later, the conducting film formed on the movable portion is insulated to not electrically contact electrode blocks 3 and 5 when the movable portion touches these electrode blocks.

A similar 50 V voltage can be placed on the opposite electrode block to draw the guide across to the opposite electrode block, while removing the 50 V applied to the first electrode block. In one embodiment, two output guides 7 and 9 are located in such a way that, when the moving guide 1 is next to the electrode block 3, the output of guide 1 is directed into output guide 7. Likewise, when the moving portion of guide 1 is drawn next to electrode block 5, the output of guide 1 is directed to output guide 9.

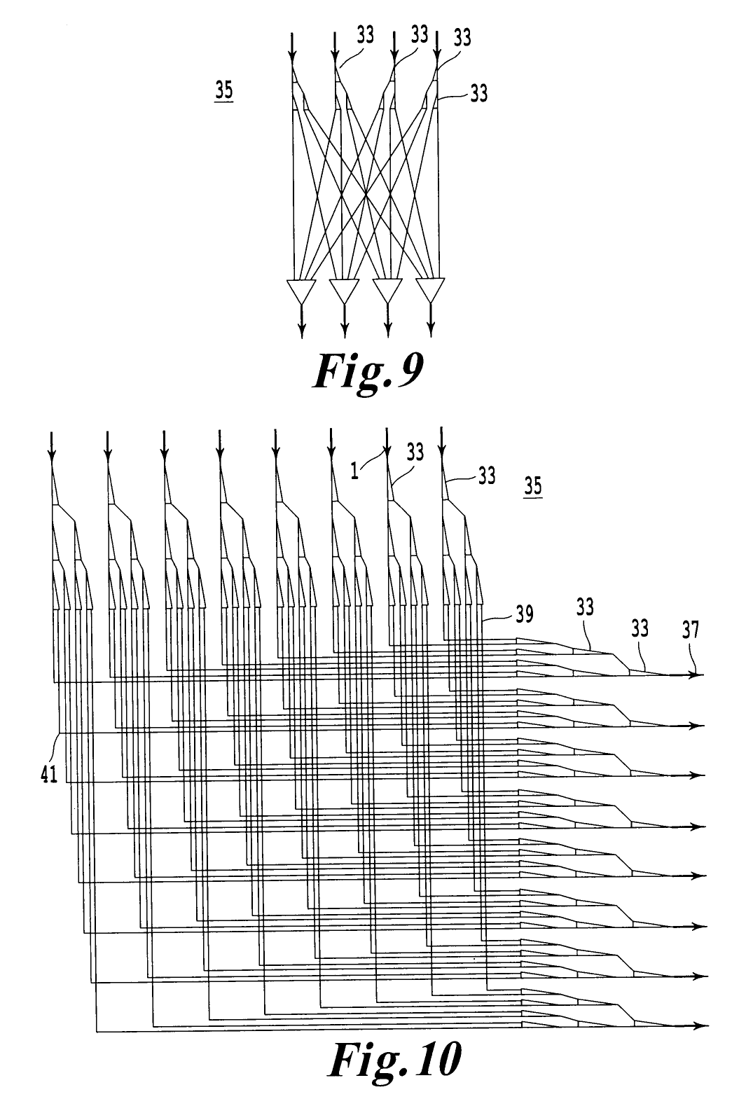

In one embodiment, output guides 7 and 9 are attached to the surface of substrate 27 through an appropriate cladding layer in the same way as input guide 1. Output guides 7 and 9 may be positioned on the substrate 27 to serve as inputs to additional switches or to other guide circuit elements to make multiplex switching elements. For optical communications, the multiplex switching elements, according to one embodiment, include structures such as cross-connects 35, shown in FIGS. 8 and 9. The cross-connect shown in FIG. 8 has two inputs and two outputs and each input signal may be output at any of the two outputs.

The optical switch element as shown in FIG. 5 includes three guides constructed of the polymer layer on the surface of substrate 25. However, more than three guides may be constructed as readily understood by one of ordinary skill in the art. A polymer is used here as an illustration of a guide material. Other materials such as glasses are also usable. Other possible organic materials include benzocyclobutene and various acrylates (e.g., polymethyl methacrylate, trade name Plexiglas), olefins (e.g., Cyclic Olefin Polymer, trade name Zeonex; Cyclic Olefin Copolymer, trade name Topas) and polycarbonates (e.g., trade name Lexan), as well as fluorinated versions of polyimide and other plastics.

A portion of input guide 1 and all of the two output guides 7 and 9 are attached to a surface of substrate 25. However, in another embodiment, the end faces of output guides 7 and 9 may also have movable portions that may move relative to the surface of substrate 27 and may have corresponding conducting films and stop electrode blocks to further align the output guides with the input guide 1 or other guides.

The movable portion 1d of the input guide 1 that is near the output guides 7 and 9 is detached from the surface of the substrate 27, forming a cantilever, and this portion is allowed to move. According to one embodiment, the length of the movable portion is less than 1 mm and a distance between the movable portion hanging over the substrate and the substrate is about 1 μm. In general, the length of the movable portion depends on various factors, as for example the stiffness and other mechanical properties of the material from which the guide is made.

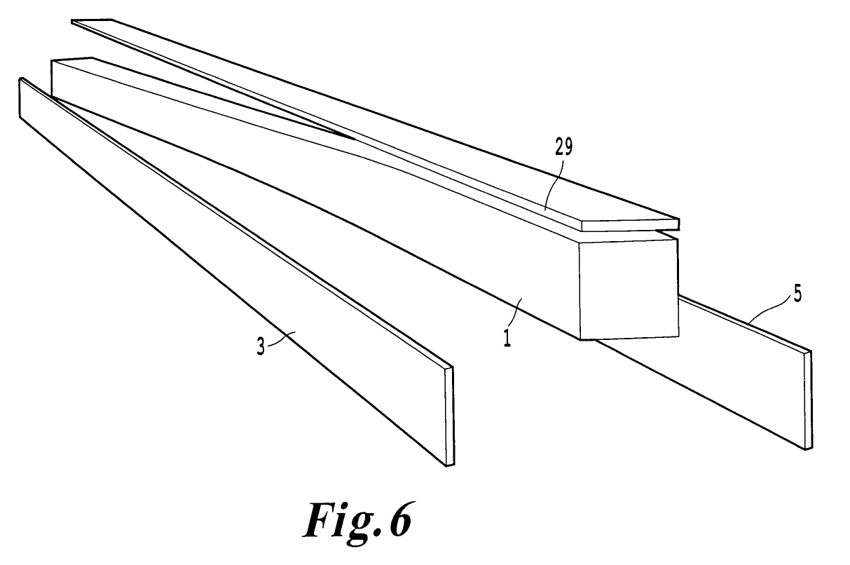

The above discussed structure may be extended to a guide having more than two positions, by adding additional electrode blocks. In this respect, FIG. 6 shows, beside the electrodes 3 and 5, at least one electrode 29 arranged above the guide 1 in order to actuate the guide 1 along a vertical direction. In this case, guide 1 has supplemental electrodes to electrostatically interact with the electrode 29.

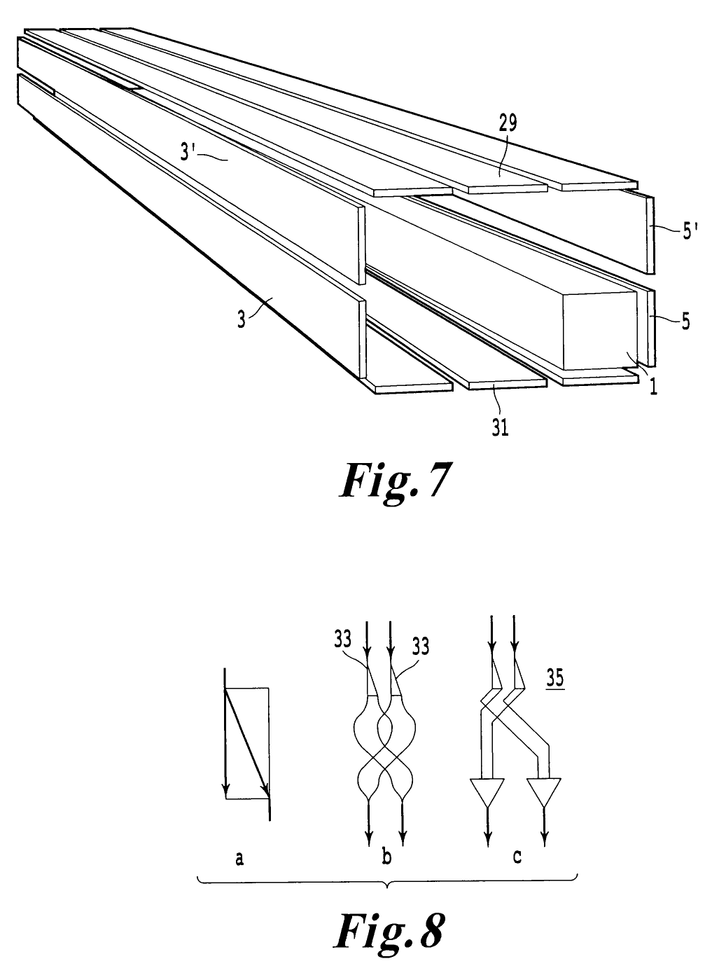

In a further embodiment, FIG. 7 shows plural lateral electrodes 3, 3′, 5, 5′, 29, and 31 that permit the movement of the guide to six different positions that correspond to six different output guides (not shown). In this embodiment, three of the outputs are produced in the same way as was described above for the case with two outputs, i.e., a surface is formed that includes an input guide, with a movable section, that may be aligned with any of three outputs. To produce six outputs, three additional outputs are produced on a surface that includes outputs and electrode blocks, but no input guide. This additional surface is rotated over the top of the first surface and is aligned and held in place by “bump-bonding” or “flip-chip” techniques. The electrostatic force from the electrode blocks in the top surface lifts the moving portion of the input fiber from the bottom surface to align with an output guide in the top surface. For three outputs, a buried electrode in the center of the top surface is used to attract the light guide to the center of the top surface. This arrangement is discussed in more detail later.

Any combination of electrodes is possible, including but not limited to 2×3 electrodes as shown in FIG. 7 or the electrodes being disposed on a single vertical side and a single horizontal side around the guide.

The electrostatic switch design discussed above in one embodiment is used to make an integrated optical cross connect. For simplicity, the two-output switch shown in FIG. 5 is represented as a rectangular symbol in FIG. 8a. Using two switches as shown in FIG. 8b, a 2×2 optical cross-connect can be produced using the polymer guides shown in FIG. 5. A schematic representation of the circuit using simplified symbols is shown in FIG. 8c.

Twelve of the processed optical switches can be used to make an integrated 4×4 optical cross connect as shown in FIG. 9. The symbols are the same as shown in FIG. 8c. Likewise, the switches can be combined with guide gratings to produce optical multiplexers.

In another embodiment, FIG. 10 shows a plurality of switches to form a router. For example, two groups of three rows of optical switches allow any of eight inputs to be switched into any of eight outputs in either direction using a planar guide circuit. The small triangles in FIG. 10 represent optical switches with one input and two outputs. The right angle connections 41 represent total-internal-reflection corner reflectors. The corner reflectors produce a smaller optical circuit with the cost of increasing light loss due to the right angle connections. In another embodiment, the change of direction could be accomplished using smoothly curved guides, such as by using a “Recursive Tree Structure” with curved crossings that produces an integrated optical switch matrix (described by F. L. W. Rabbering, J. F. P. van Nunen and L. Eldada, in “Polymeric 16×16 Digital Optical Switch Matrix, 27^{th} European Conference on Optical Communication, Volume 6, Pages 78-79, 2001, the entire content being incorporated by reference herein).

The embodiment of the present invention provides a switching structure that takes an input from an optical fiber or other source and directs the signal unambiguously to one of many possible output paths in the same bank of switches or in an adjacent bank of switches. This described structure is simpler and less costly then MEMS mirror switches and faster in operation than typical thermal switches.

Also, according to one embodiment of this invention, a microfabricated array of optical switches 33 (see FIG. 8) is provided, and the array can route an input optical signal to one of many possible outputs in the same bank of switches or an adjacent bank of switches. The simple design operates with low-current electrostatic activation.

In addition, according to one embodiment of this invention, an optical switch array 35 (see FIGS. 9 and 10) is fabricated on a single substrate with multiple outputs. This design uses little electrical power to operate. Optical inputs 1 can be switched to selected optical outputs 37 without conversion to intermediate electronic signals. The planar fabrication permits inexpensive production. The integrated blocks for stopping the movement of the guides make the structure rugged and stable, even in a moving vehicle. The electrostatic activation of the switches 33 operates much faster and with less power than the thermal activation used in some other designs.

The guides are sized appropriately for their application. For use with single-mode optical fiber, the guides are about 10 μm wide. For use with a multi-mode optical fiber, the guides are about 60 μm wide. Depending on the application, other sizes can be chosen. The length of the switch will vary depending on the width of the fibers and the elasticity of the material from which the fibers are made.

The arrays of switches 33 are fabricated on a plane substrate. Outputs of switch units are sent into inputs of later switch units so that a given input signal can be sent into one of a large number of potential outputs. Plane arrays of switches can be stacked together, such as by “flip-substrate” technology, so that signals from one plane array can be switched into another adjacent array. This increases the density of switches at low cost.

There are a variety of possible configurations for the embodiments of this invention. It is anticipated that the outputs of basic switch units 33 are carried to inputs of further switch units 33, by optical fibers 39, by further guides, or other means. The basic switch units may have a variety of output configurations. Rather than having a neutral center position for the input guide (i.e., for a rest position of the input guide, the end face of the movable portion is not aligned with an end face of an output guide), as in FIG. 5, there may be an output position at the center. Such an output arrangement would yield three possible output positions. By placing appropriate electrodes on the plane surface below the guide, in addition to electrodes on the stop blocks, it would be possible to have four output positions per switch unit. By placing a second surface above the first surface, by some means such as “flip-substrate” technique, it would be possible to add three or four output positions, thus yielding six or eight outputs per switch unit. It is noted that the distance between the output positions must be large enough to prevent light from escaping the guide and entering any output except the one that was intended.

In this respect, to help maximize the transfer of the optical signal, the ends of the output light guides that face the input light guide are slightly flared. In this way, if the two light guides do not meet in perfect alignment, the flared ends still collect most of the light. While the light guides are generally about 10 μm in width, the flared ends are about 12 μm in width in one embodiment. However, other widths are possible.

Additionally, the output light guides are separated by a distance to limit the possibility of light intended for one output entering another output. In one embodiment, the separation distance is about 18 μm. Selecting a separation equal to the width of the input light guide plus two wavelengths of the transmitted light at each side, for infrared communications wavelengths for example, would yield 10 μm+(2×2×1.5 μm)=16 μm.

Next, a fabrication method of the guide 1 is discussed. The above discussed optical switch may use polymer guides but also other materials, such as but not limited to spin-on glasses.

Making a polymer optical switch as shown in FIG. 5 starts on a wafer substrate 100, typically a silicon wafer. Patterned base layers are added to provide electrical and optical isolation, as well as electrical connections to the electrode blocks 3 and 5 and the cantilevered input guide 1. Layers are typically metals, polymers or oxides. In the switching region 25, under the guide 1, a layer 108 that can be removed by chemical action, thermal sublimation, or other methods is provided. This will allow the corresponding part of the input guide to be free to move after the removal of that layer.

Above these layers, an additional layer 114 is added and patterned to form the input guide, the two output guides, and the two electrostatic blocks. The next step is to apply the metal 116 for electostatic activation of the structure. One approach is to do an angled evaporation of metal onto the edges of the guide facing the electrostatic electrode blocks and electrode blocks themselves. Also, the metal serves to connect these side elements to contact pads for the control circuits.

The structural design and fabrication process is controlled to mask all of the areas where the metal is not wanted and then later remove other portions of it by conventional physical or chemical etching method. An additional fabrication step is the formation of an insulating sidewall 126 covering the metal sidewalls to prevent shorting. The final fabrication step is to remove the release layer 108, mechanically freeing a portion 1d of the input guide 1.

Future refinements to improve light transmission may include an anti-reflection coating on the ends of the guides to help reduce reflections. Additional changes may also include the use of a fluid surrounding the switch other than air. The index of refraction of the fluid will be chosen to be greater than that of air and less than that of the guides, in order not to defeat the cladding requirement.

The design discussed above is more compact than conventional optical switches. Because the guide is its own actuator, and the stop blocks are short distance apart, many switches can be fabricated on a single wafer. This allows for economy of scale, thus reducing the cost of the switch. Also, this structure allows complex circuits to be made including the switch on a single wafer providing the economy of large-scale integration. Electrostatic activation of the guide assures that the switch requires low power.

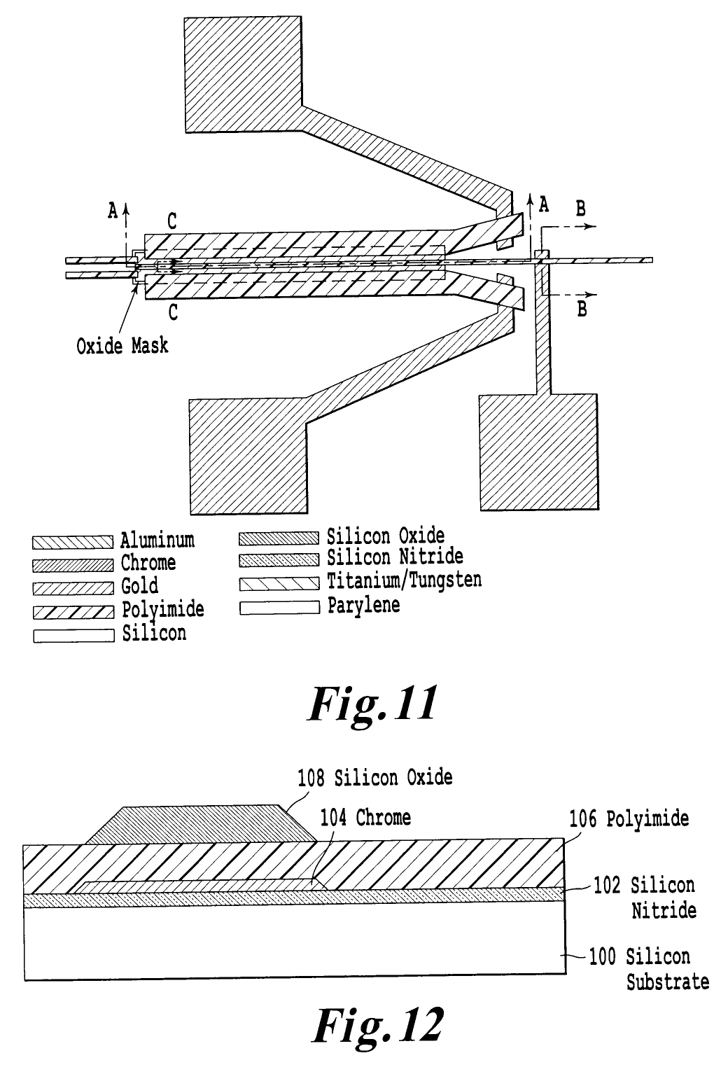

The fabrication process of the optical switch disclosed above is discussed in more details with reference to FIGS. 11-24. FIG. 11 shows the processed optical switch with a key to materials to be used during the fabrication. However, other materials can be used as will be appreciated by one skilled in the art of producing optical fibers. FIG. 11 also indicates various cross-sections that will be illustrated later.

As shown in FIG. 12, a Si₃N₄ layer 102 is deposited for example by LPCVD on the substrate 100, which might be a silicon wafer. The Si₃N₄ layer may have a thickness of 1500 ÅA. This LPCVD method produces a uniform coating over the entire substrate 100. The nitride provides an “etch barrier” to stop the “release etch” at the end of the process that is used to remove the sacrificial oxide from underneath the movable portion of guide 1 to be formed. The nitride also provides an insulating layer between electrical contacts and the substrate 100. Optionally, it is possible to coat a front side of the substrate 100 with a resist, to protect the nitride layer, and to reactive ion etching (RIE) a back of the substrate 100 to remove the nitride there. This optional step allows an electrical contact with the silicon substrate if desired. After this process, the resist may be removed from the front side of the wafer.

Next, a resist layer is applied to the front side of the wafer and the resist is patterned through a first mask. The purpose of the first mask is to produce a conductive metal electrode below the moving portion of the guide 1 to prevent the guide from bending toward the substrate due to electrostatic attraction.

A Cr layer 104 having a thickness of 1000 Å is formed on the silicone nitride layer 102. If a stress is large in the Cr layer 104, a Cr/Au/Cr combination of layers having a thickness of 150 Å/1000 Å/150 Å may be deposited on the silicone nitride 102 by evaporation. Then, the resist and excess metal is removed with a liftoff process.

Further, a first polyimide layer 106 having a thickness of 1 μm is uniformly coated over the entire wafer. The polyimide is cured after coating. A patterned resist is deposited over the polyimide with a second mask to open vias down to a bottom of a metal electrode. Then the polyimide is ME etched and the resist is removed. Next, an oxide 108 is deposited by PECVD to have a thickness of 1 μm. Another resist is deposited and patterned with a third mask (for the release layer under the moving portion of the guide). The oxide layer 108 is wet etched to form a more sloped edge as shown in FIG. 12. Then, the resist is removed.

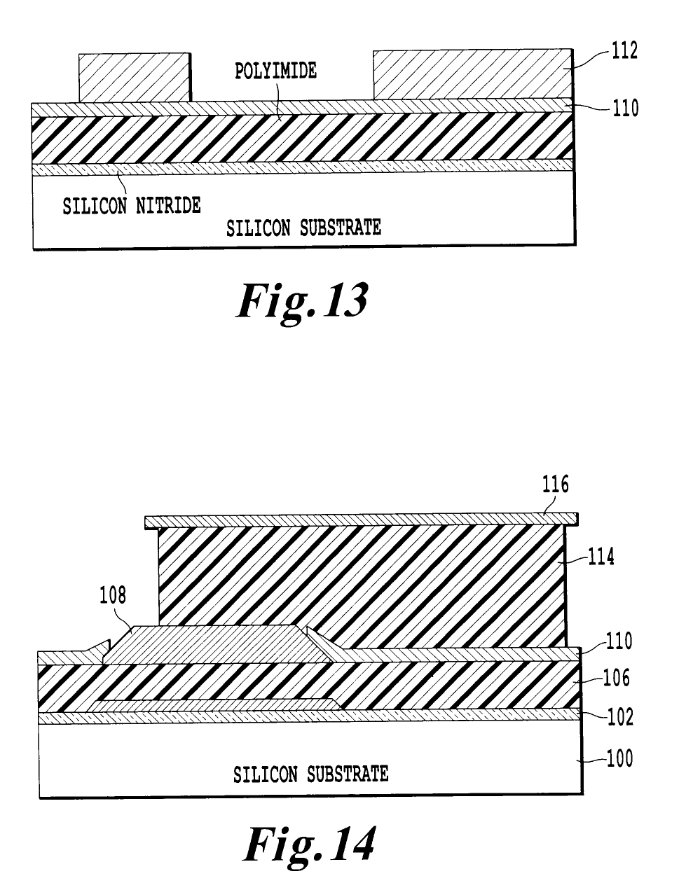

Next, as shown in FIG. 13, (which shows a B-B cross section of the partial device), a resist is patterned by using a fourth mask (for a thin blanket layer of metal to provide an etch stop for etching the polymer guide). Aluminum is evaporated to form layer 110 with a thickness of 1000 Å. Optionally, Al/Cu is evaporated, where Cu is added to reduce the formation of hillocks. Then, the resist and excess metal are removed. The metal layer 110 also serves as a reflective cladding for the bottom of the guide 1, although a reflective cladding is not needed where the guide is cantilevered over empty space by removal of the release layer. Instead of the reflective cladding, an optically superior method is to use a lower-index transparent material for cladding by total internal reflection, as will be discussed later.

As shown in FIG. 13, a resist is patterned with a fifth mask to produce metal lead lines to the guide and electrodes as well as pad metal for wirebonding the completed device. Aluminum (or Al/Cu) is deposited to form a layer 112 having a thickness of 9000 Å. Afterwards, the resist and excess metal are removed.

Optionally, the metal layer could be thinner, to enhance the optical characteristics of the guide, and an extra mask may be used after these steps to deposit and pattern thicker metal for the wirebonding pads.

A second polymide layer 114 is deposited (coated and cured) with a thickness of 9 μm. Optionally, the single polyimide layer 114 can be replaced by a three-layer polymer stack with thin, lower-refractive-index materials at the top and bottom of the stack, cladding the polyimide in the middle to form a core of the guide, where the light is trapped in the polyimide. Parylene is a possible material for the cladding. A Ti/W layer 116 is deposited, for example by sputtering, with a thickness of 3000 Å. A resist is patterned by using a sixth mask to define the guide and the deflection electrodes. The Ti/W layer is used an etch mask for the next step, which is to RIE the 9 μm polyimide layer. Then the layer of Ti/W is RIE etched.

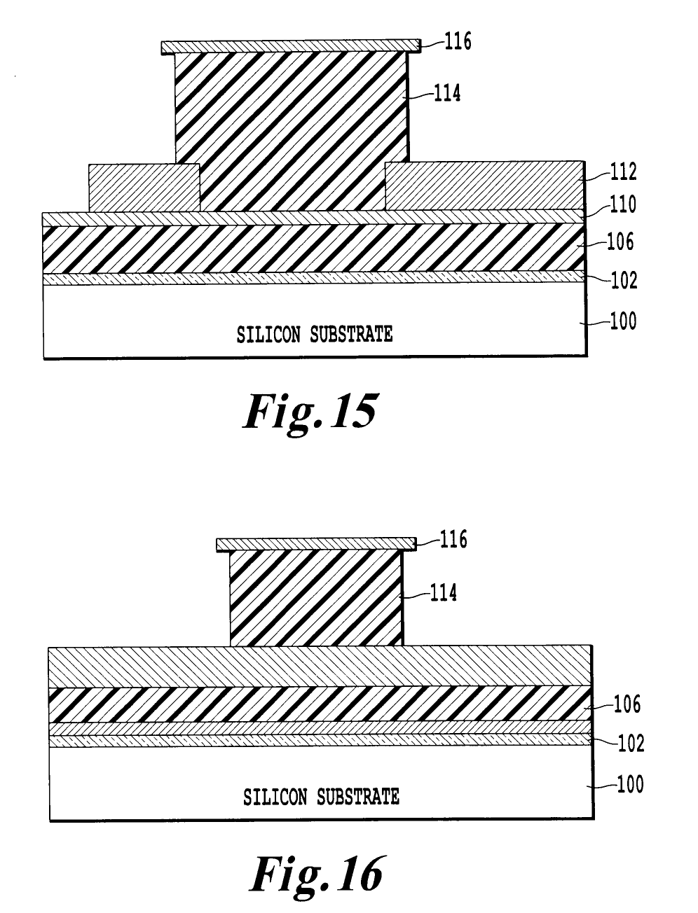

FIG. 14 shows the partial device in the A-A cross-section, FIG. 15 shows the same partial device in the B-B cross-section, and FIG. 16 shows the same partial device in the C-C cross-section.

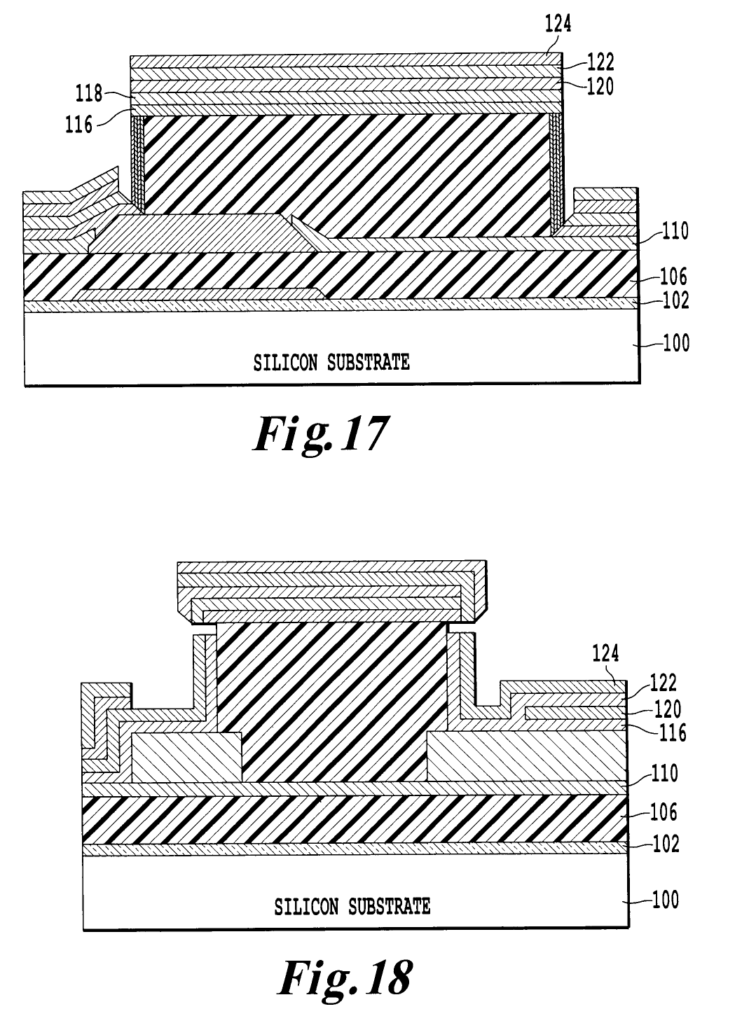

As shown in FIG. 17 in this embodiment, Al is angle evaporated to form a layer 118 having a thickness of 250 Å, followed by a 2000 Å layer 120 of Au, followed by rotation by 180 degrees, followed by a 250 Å layer 122 of Al angle evaporated, followed by a 2000 Å layer 124 of Au. This stack of layers 118-124 produce a coating on both sides of the guide 1 as shown in FIG. 17 (cross-section A-A), FIG. 18 (cross-section B-B), and FIG. 19 (cross-section C-C). The next step is to ion mill off the top of the stack Au/Al/Au/Al and the 1000 Å Al bottom layer.

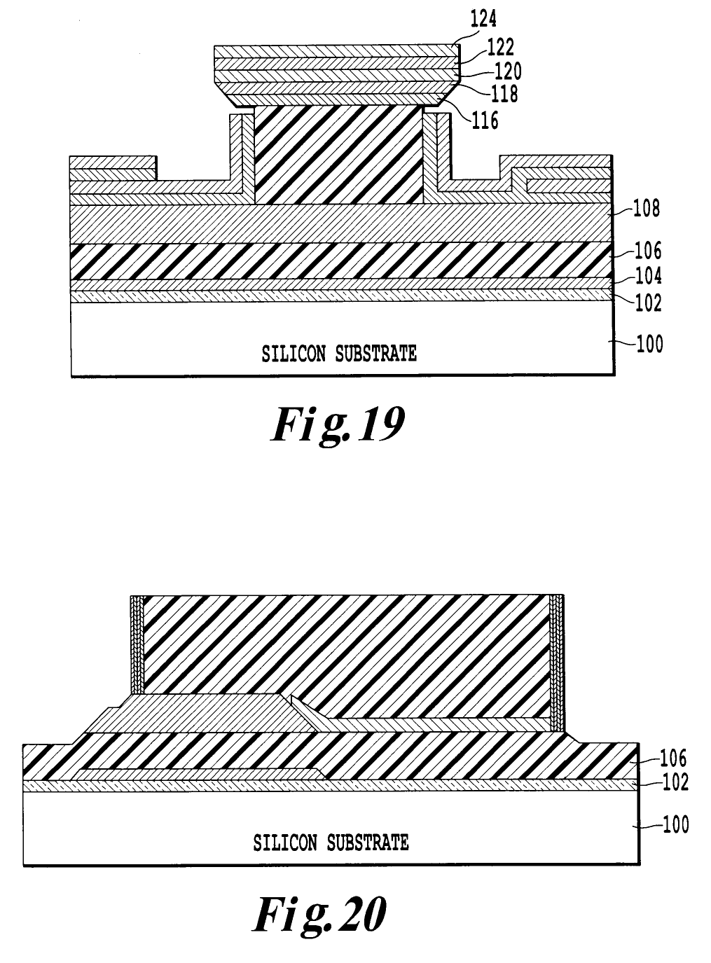

FIG. 20 shows the Ti/W layer having been etched with a wet etch process to achieve a good selectivity. If the selectivity is good, RIE may be used. A photoresist is patterned with a seventh mask to expose the ends of the light guides and the sides of the passive guides. Metal sidewalls are removed from the guides for decreased light loss and also to remove metal from the end of the guides for better light transmission. The layers of Au/Al/Au/Al are wet etched from exposed sidewalls and then the photoresist is removed.

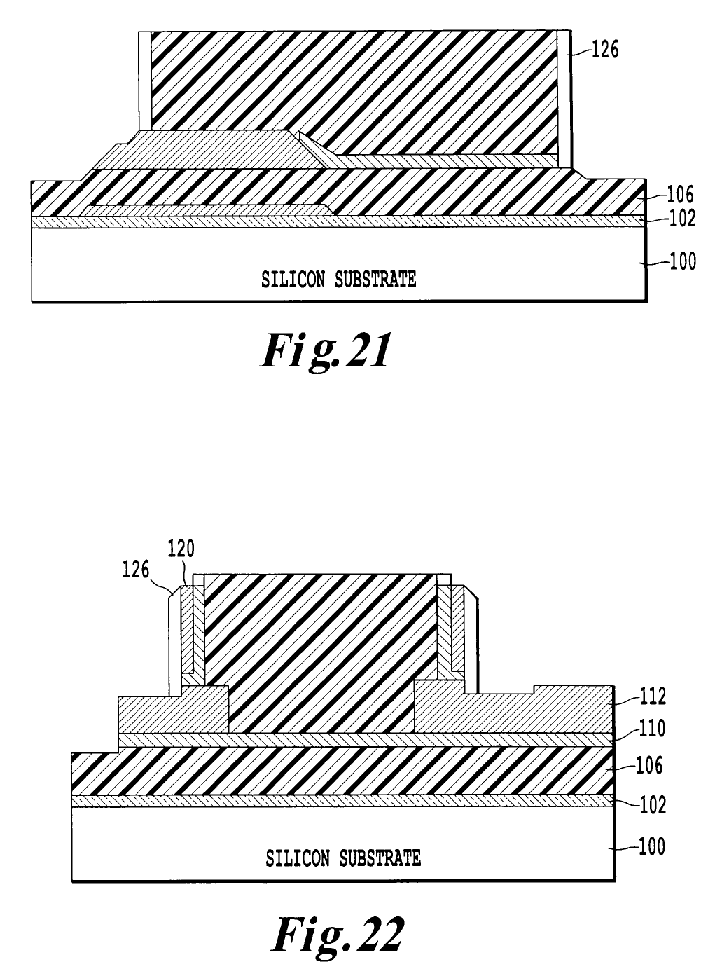

A layer 126 of Parylene having a thickness of 4000 Å is deposited to produce a uniform coating over the entire device and then, the layer 126 of Parylene is RIE etched with anisotropic etch, removing Parylene from top surfaces of the guide and leaving Parylene on the sides of the guide, as shown in FIG. 21. The parylene layer 126 serves as an electrical insulation between the electrodes of the guide and the deflection electrodes.

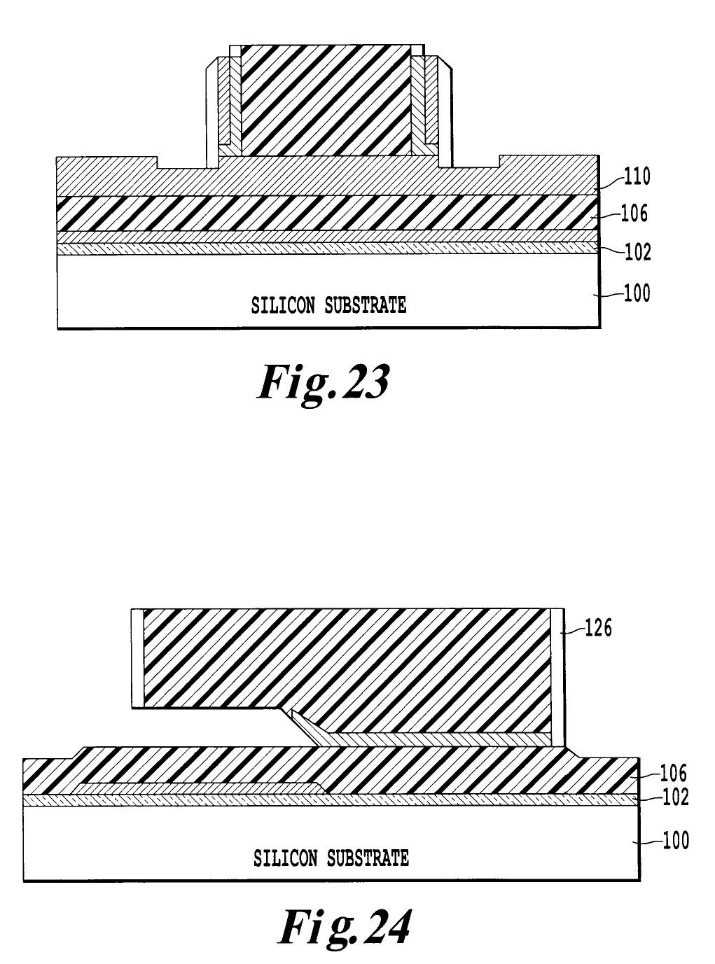

FIG. 22 shows the parylene layer 126 deposited on sides of the guide and also shows the conductive films 118,120, 122 and 124 of the guide in the B-B cross-section. FIG. 23 shows the same device in the C-C cross-section.

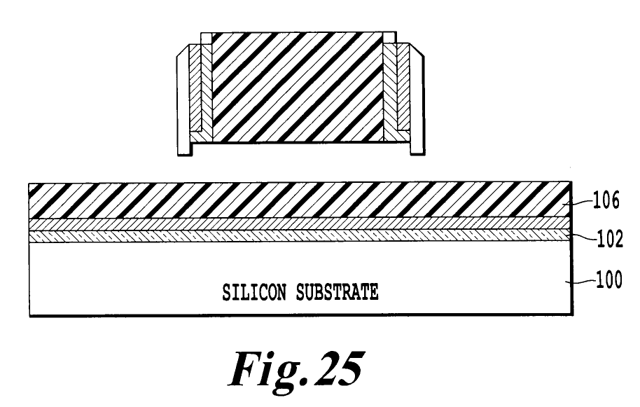

As shown in FIG. 24, the oxide layer 108 is wet etched to release the movable portion of the guide 1 and then the whole structure is supercritical CO, dried. FIG. 25 shows the final optical switch in the C-C cross-section. As alternatives to the steps described above, planetary evaporation or sputtering may be used instead of angle evaporation and the TiW layer may be removed at different steps during the process, for example after the polyimide etch.

Thus, by using the above disclosed method, an optical switch as shown in one of FIGS. 1-5 can be obtained. Similar steps can be used to produce the optical switches shown in FIGS. 8a-11.

Numerous modifications and variations of the present invention are possible in light of the above teachings. It is therefore to be understood that within the scope of the appended claims, the invention may be practiced otherwise than as specifically described herein.

1. An optical device for switching an optical signal between a first optical path and a second optical path, comprising:
a substrate;
a first guide forming at least a portion of the first optical path, formed on the substrate, and having a movable portion separated from the substrate;
a second guide forming at least a portion of the second optical path and disposed adjacent to the first guide; and
means for electrostatically bending the movable portion so as to optically couple the first guide to the second guide.

2. The device of claim 1, further comprising:
a third guide forming at least a part of a third optical path, disposed adjacent to the first guide and configured to be optically coupled to the first guide when the movable portion of the first guide is electrostatically bent by the means for electrostatically bending.

3. The device of claim 1, further comprising:
a third guide forming at least a part of a third optical path, disposed adjacent to the first guide and configured to be optically coupled to the first guide when the movable portion of the first guide is not bent.

4. An optical device for switching an optical signal between a first optical path and a second optical path, comprising:
a substrate;
a first guide forming the first optical path, formed on the substrate, and having a movable portion separated from the substrate, the movable portion including,
an end face disposed at a longitudinal end of the movable portion, and
first and second side walls adjoining the end face;
a first conducting layer formed on the first side wall of the movable portion;
a first electrode protruding from the substrate, opposing the movable portion, and configured to electrostatically bend the movable portion of the first guide when a first voltage is applied between the first electrode and the first conducting layer; and
a second guide forming the second optical path, disposed adjacent to the end face of the first guide, and optically coupled to the first guide when the movable portion of the first guide is electrostatically bent by the first voltage.

5. The device of claim 4, wherein the first guide contacts the first electrode when the first and second guides are optically coupled.

6. The device of claim 4, further comprising:
a medium extending between the first guide and the second guide to reduce optical scatter there between.

7. The device of claim 4, further comprising:
a second conducting layer formed on the second side wall of the movable portion;
a second electrode protruding from the substrate, opposing the movable portion, and being configured to electrostatically bend the movable portion of the first guide when a second voltage is applied between the second electrode and the second conducting layer; and
a third guide forming a third optical path disposed adjacent to the end face of the first guide and configured to be optically coupled to the first guide when the movable portion of the first guide is electrostatically bent by the second voltage.

8. The device of claim 7, wherein the first guide contacts the second electrode when the first and third optical guides are optically coupled.

9. The device of claim 7, further comprising:
a medium between the first guide and the third guide to reduce optical scatter there between.

10. The device of claim 7, wherein the first guide is disposed between the first and second electrodes.

11. The device of claim 7, wherein the first and second electrodes are arranged at equal angles with respect to the first guide.

12. The device of claim 4, further comprising:
a third guide forming a third optical path disposed adjacent to the end face of the first guide and configured to be optically coupled to the first guide when the movable portion of the first guide is not bent.

13. The device of claim 4, wherein the movable portion is separated from the substrate by a predetermined distance.

14. The device of claim 4, further comprising:
an anti-reflection layer coated on at least the end face of the movable portion or an end face of the second guide.

15. An optical routing apparatus comprising:
a plurality of optical devices according to claim 4; and
a plurality of optical fibers connecting the plurality of optical devices.

16. An optical router comprising:
a plurality of optical devices according to claim 4;
a plurality of optical fibers connecting the plurality of optical devices; and
a plurality of optical connections configured to couple the optical fibers between the optical devices.

17. The optical router of claim 16, wherein the optical connection is a right angle connection.

18. An optical device for switching an optical signal from an input optical path to one of plural output optical paths, comprising:
a substrate;
an input guide forming the input optical path, formed on the substrate, and having a movable portion separated from the substrate, the movable portion of the input guide including,
an end face disposed at a longitudinal end of the movable portion, and side walls adjoining the end face;
conducting layers formed on the side walls of the movable portion; and
electrodes connected to the substrate, separated from the input guide, opposing respective ones of the conducting layers, at least partially surrounding the movable portion of the input guide, and configured to electrostatically bend the movable portion of the input guide when a corresponding voltage is applied between one of the electrodes and one of the conducting layers;
output guides forming the output optical paths disposed adjacent to the end face of the input guide; and
the input guide is optically coupled to a selected one of the plural output guides when the movable portion of the input guide is electrostatically bent.

19. The device of claim 18, wherein the electrodes include between 3 and 12 electrodes.

20. The device of claim 18, wherein the conducting layers include 4 conducting layers.

21. The device of claim 18, wherein a number of the conducting layers is equal to a number of the electrodes.

22. The device of claim 18, wherein the substrate includes plural substrate portions.

23. The device of claim 18, wherein the substrate includes plural substrate portions each having a same number of electrodes formed thereon.

24. The device of claim 18, wherein respective conducting layers are formed on a respective side wall of the side walls of the movable portion.

25. A method for switching an optical signal between a first guide and a second guide, comprising:
introducing the optical signal into a movable portion of the first guide formed on a substrate, said movable portion separated from the substrate supporting the movable portion; and
electrostatically bending the movable portion of the first guide to optically couple the first guide to the second guide.

26. The method of claim 25, wherein the electrostatically comprises:
applying a first voltage to electrostatically bend the movable portion of the first guide to optically couple the first guide to the second guide.

27. The method of claim 25, further comprising:
applying a second voltage to electrostatically bend the movable portion of the first guide to optically couple the first guide to a third guide disposed adjacent to the first guide.

28. A method for switching an optical signal from an input guide to one of plural output optical guides, comprising:
introducing the optical signal into a movable portion of the input guide formed on a substrate, said movable portion separated from the substrate supporting the movable portion; and
electrostatically bending the movable portion of the input guide a selected amount to selectively optically couple the input guide to a selected one of the plural output optical guides.
